(19) United States
(12) Patent Application Publication
(10) Pub. No.: US 2016/0293968 A1
(43) Pub. Date: Oct. 6, 2016

(54) ULTRATHIN ONE-DIMENSIONAL BINARY PALLADIUM NANOSTRUCTURES AND METHODS OF MAKING SAME

(71) Applicant: The Research Foundation for The State University of New York, Albany, NY (US)

(72) Inventors: Stanislaus Wong, Stony Brook, NY (US); Christopher Koenigsmann, Mahopac, NY (US); Haiqing Liu, Port Jefferson Station, NY (US)

(21) Appl. No.: 15/092,366

(22) Filed: Apr. 6, 2016

Related U.S. Application Data
(60) Provisional application No. 62/143,553, filed on Apr. 6, 2015.

(51) Int. Cl. H01M 4/92; H01M 4/88

(52) U.S. Cl. CPC H01M 4/921; H01M 4/8828; H01M 4/928

(57) ABSTRACT

The present invention provides a method of producing ultrathin palladium-transitional metal composite nanowires. The method comprises mixing a palladium salt, a transitional melt salt, a surfactant and a phase transfer agent to form a mixture. The transitional metal is selected from the first row transitional metals. A reducing agent is added to the mixture; and the nanowires are isolated. The relative amount of the palladium and the transitional metal in the mixture correlate to the atomic ratio of the palladium and transitional metal in the composite nanowires. The amount of palladium is at least 60%. The diameters of the composite nanowires are from about 1 nm to about 10 nm.

### CROSS-REFERENCE TO RELATED APPLICATIONS

This application claims the benefit of U.S. Provisional Application Ser. No. 62/143,553, filed Apr. 6, 2015, which application is incorporated herein by reference in its entirety.

This invention was made with government support under grant number DEAC0298CH10886 awarded by the Department of Energy. The government has certain rights in this invention.

### BACKGROUND OF THE INVENTION

Recently, a class of electrochemically active single-crystalline one-dimensional (1-D) nanostructures has been developed. In general, 1-D materials possess high aspect ratios, fewer lattice boundaries, longer segments of smooth crystal planes, and a relatively low number of surface defect sites, all of which are desirable attributes for fuel cell catalysts. In this context, the performance of binary Pd-based alloys (i.e. Pd₁₋ₓAuₓ and Pd₁₋ₓPtₓ) toward the oxygen reduction half-cell reaction (ORR) and the methanol oxidation reaction (MOR) has been dramatically improved by tailoring the morphology, size, and chemical composition. As a salient example, it was recently demonstrated that optimization of size and composition in “Pt-free” Pd₉Au NWs can lead to a measured ORR activity of 0.49 mA/cm², which represents more than a two-fold improvement over commercial Pt NP/C catalysts. For PdAu systems, studies showed that the enhanced performance likely arises from the structural and electronic properties associated with their alloy-type structure and not simply due to the coincidental physical presence of interfacial Pd—Au pair sites (Koenigsmann et al., J. Phys. Chem. C., 2012, 116(29):15297-15306).

Ultrathin 1-D structures combine the merits of extended, smooth facets associated with an anisotropic morphology along with high surface area-to-volume ratios due to their nanometer-scale dimensions, all of which combine to give rise to highly promising functional attributes for these materials as electrocatalysts. Excellent enhancements have also been noted with ultrathin, core-shell Pt˜Pd₁₋ₓAuₓ NWs, wherein the mutual benefits of the 1D morphology and ultrathin size are combined with a hierarchical structural motif. After the ensuing deposition of a Pt monolayer, a volcano-type composition dependence was observed in the ORR activity values of the Pt˜Pd₁₋ₓAuₓ NWs as the Au content is increased from 0 to 30% with the activity of the Pt˜Pd₉Au NWs (0.98 mA/cm², 2.54 A/mg_{Pt}), representing the optimum performance.

However, the gold-based alloys have a relatively high cost. Moreover, the relationship between composition and the corresponding ORR activity has yet to be systematically analyzed.

### SUMMARY OF THE INVENTION

In one embodiment of the present invention, a method of producing ultrathin palladium-transitional metal composite nanowires are provided. The method comprises mixing a palladium salt, a transitional melt salt, a surfactant and a phase transfer agent to form a mixture, wherein the transitional metal is selected from the first row transitional metals; adding a reducing agent to the mixture; and isolating the nanowires. The relative amount of the palladium and the transitional metal in the mixture correlate to the atomic ratio of the palladium and transitional metal in the composite nanowires. The amount of palladium is at least 60%. The diameters of the composite nanowires are from about 1 nm to about 10 nm. Typically, the palladium salt is palladium(II) nitrate. Typically, the transitional metal salt is nickel(II) chloride. An example of a nanowire is PD_{0.9}Ni_{0.1}. Typically, the surfactant is octadecylamine. Typically, the phase transfer agent is dodecyltrimethylammonium bromide. Typically, the reducing agent is sodium borohydride. Typically, the diameters of the composite nanowire is less than about 10 nm, more typically, about 2 nm.

In one embodiment, the present invention provides a method to remove residual surfactant from composite nanowires. The method comprises dispersing composite nanowires in butylamine to exchange the surfactant with the butylamine; and depositing the nanowires onto a glassy carbon electrode and cycling the potential from zero up to about 1.5V at a rate of about 100 mV/second.

In one embodiment, the present invention provides ultrathin palladium-transitional metal composite nanowires having diameters of about 1 nm to about 10 nm and having formula of Pd₁₋ₓYₓ, wherein x is at most 0.5, and Y is a first row transitional metal. Typically, the ultrathin palladium-transitional metal composite has a diameter of about 2 nm. Typically, the ultrathin palladium-transitional metal composite nanowires have specific activities of about ±1.0 mA/cm² the specific activity of Pd nanowires. Typically, the ultrathin palladium-transitional metal composite nanowires maintain at least about 70% of their area activities in the presence of about 4 mM methanol.

In one embodiment, the ultrathin palladium-transitional metal composite nanowires are surrounded by a platinum monolayer. Typically, the ultrathin palladium-transitional metal composite nanowire with the surrounding platinum monolayer has formula Pt˜Pd_{0.90}Ni_{0.10} and an area activity of about 0.5 to about 0.8 mA/cm² and a mass activity of about 1 to 2 A/mg_{Pt}.

In one embodiment, the present invention provides an ambient, surfactant-based synthetic method to prepare ultrathin, composition-tunable Pd—Ni one-dimensional nanostructures possessing high structural uniformity and a homogeneous distribution of elements. The electrochemical activities of the carbon-supported Pd—Ni were examined. Two of the compositions, namely Pd_{0.90}Ni_{0.10} and Pd_{0.83}Ni_{0.17}, exhibited either similar or higher specific activities by comparison with elemental Pd NWs, while all four chemical compositions of the nanowires tested, which were involved in electrochemical tests (namely elemental Pd, Pd_{0.90}Ni_{0.10}, Pd_{0.83}Ni_{0.17}, and Pd_{0.75}Ni_{0.25}) possessed measurable enhancement as compared with commercial Pd nanoparticles. More importantly, as a positive indicator of the potential practicality of the invention, the Pd_{0.90}Ni_{0.10} sample exhibited outstanding methanol tolerance ability. In essence, there was only a 15% loss in the specific activity in the presence of 4 mM of methanol.

In another embodiment, the present invention provides ultrathin, core-shell Pt˜Pd_{0.90}Ni_{0.10} nanowires, which exhibited a specific activity of 0.62 mA/cm² and a corresponding mass activity of 1.44 A/mg_{Pt}. Moreover, the as-prepared core-shell catalyst maintained excellent electrochemical durability under realistic testing conditions with the specific activity of the present as-prepared electrocatalysts actually increasing by more than 20% after 10000 cycles from 0.62 mA/cm² to 0.76 mA/cm².

In a further embodiment, 1-D Pd—Ni nanostructure ORR catalysts are provided. These catalysts are a more earth-abundant, lower cost, high-performance, and therefore attractive alternative to the conventional use of Pt nanoparticles as ORR catalysts.

### BRIEF DESCRIPTION OF THE DRAWINGS

FIG. 1. Characteristic EDAX spectra have been collected from a series of Pd—Ni NW composites of various chemical compositions.

FIG. 2A. Cyclic voltammograms obtained from a series of butylamine-treated ultrathin Pd—Ni NWs by comparison with elemental Pd NWs.

FIG. 2B. The corresponding experimentally calculated area-normalized kinetic current densities (Jₖ, mA/cm²).

FIG. 3A. Representative polarization curves obtained from Pd_{0.90}Ni_{0.10} NWs with analogous Pd NWs serving as a comparison.

FIG. 3B. Data on specific activities (mA/cm²) of Pd_{0.90}Ni_{0.10} nanowires, elemental Pd nanowires, and commercial Pd nanoparticles.

FIG. 3C. A potential versus specific activity plot (E versus Jₖ) for these two nanowires.

FIG. 4A. Probing the methanol tolerance capability of as-processed Pd_{0.90}Ni_{0.10} NWs. Polarization curves were obtained in the presence of various methanol concentrations, ranging from 0 to 4 mM.

FIG. 4B. A plot of the ratio of the specific activity values measured in the presence of methanol (Jₖ [MeOH]) to that measured in pure electrolyte (Jₖ) as a function of increasing methanol concentration for Pd_{0.90}Ni_{0.10} NWs, with both Pt NWs and commercial Pt NP/C serving as controls.

FIG. 4C. Polarization curves obtained from Pd_{0.90}Ni_{0.10} in 0.1 M HClO₄ with increasing methanol concentrations of 25, 50, 75, and 100 mM, respectively.

FIG. 5A. Cyclic voltammograms obtained for Pd_{0.90}Ni_{0.10} nanowires and Pt˜Pd_{0.90}Ni_{0.10} core-shell nanowires, in a 0.1 M HClO₄ solution at 20 mV/s.

FIG. 5B. The polarization curves for the nanowire composites were obtained using a rotation rate of 1600 rpm in a 0.1 M HClO₄ solution at 20° C.

FIG. 5C. The electrochemical surface area activity and mass activity at 0.9 V for Pt˜Pd_{0.90}Ni_{0.10} are shown by comparison with commercial carbon-supported Pt nanoparticles, analogous Pt˜Pd nanoparticles, and ultrathin Pt˜Pd nanowires, respectively.

FIG. 6A. Cyclic voltammograms obtained in deoxygenated 0.1 M HClO₄ solution after every 5000 cycles for Pt˜Pd_{0.90}Ni_{0.10} core-shell composites. In the inset, the measured ESA loss is also shown as a function of durability cycling for the Pt˜Pd_{0.90}Ni_{0.10} architecture.

FIG. 6B. The corresponding polarization curves, obtained in an oxygen saturated 0.1 M HClO₄ at 1600 rpm after every 5000 cycles. Area-specific activities, measured at 0.9 V, are plotted as a function of durability in the inset.

### DETAILED DESCRIPTION OF THE INVENTION

The following detailed description of certain embodiments of the present invention will be made in reference to the accompanying drawings. In describing the invention, explanation about related functions or constructions known in the art are omitted for the sake of clearness in understanding the concept of the invention, to avoid obscuring the invention with unnecessary detail.

Throughout this specification, quantities are defined by ranges, and by lower and upper boundaries of ranges. Each lower boundary can be combined with each upper boundary to define a range. The lower and upper boundaries should each be taken as a separate element.

### Ultrathin Pd Nanowires

In one embodiment, the present invention provides ultrathin one-dimensional (1D) metal nanostructures including ultrathin binary (i.e., composite) nanowires. The ultrathin composite nanowire has the formula of Pd₁₋ₓYₓ, wherein Y is a first row transitional metal and x is at most 0.5. The first row transitional metals include scandium (Sc), titanium (Ti), vanadium (V), chromium (Cr), manganese (Mn), iron (Fe), cobalt (Co), nickel (Ni), copper (Cu), and zinc (Zn). In a typical embodiment the transitional metal is nickel. These nanowires have high structural uniformity and a homogeneous distribution of elements.

The diameter of the nanowire is about 0.5 nm to about 10 nm. Examples of other lower boundaries of this range include about 1 nm, about 1.5 nm, about 2 nm and about 3 nm. Examples of other upper boundaries of this range include about 6 nm, about 7 nm, about 8 nm and about 9 nm. Typically, the nanowires are about 2 nm in diameter. The aspect ratio of the nanowires is typically greater than about 5. The length of a nanowire can be up to any desired length, e.g., up to about 1 million nm.

The nanowires exhibit either similar or higher specific activities when compared with elemental Pd nanowires. In particular, the specific activities are about ±1.0 mA/cm² or about ±0.5 mA/cm² the specific activity of Pd nanowires. For example, the electrochemical activities of the carbon-supported Pd—Ni were examined. Two of the compositions, namely, Pd_{0.90}Ni_{0.10} and Pd_{0.83}Ni_{0.17}, exhibited either similar or higher specific activities by comparison with elemental Pd nanowires, whereas all four chemical compositions of the nanowires tested, which were involved in electrochemical tests (namely elemental Pd, Pd_{0.90}Ni_{0.10}, Pd_{0.83}Ni_{0.17}, and Pd_{0.75}Ni_{0.25}) possessed measurable enhancement as compared with commercial Pd nanoparticles.

Additionally, the nanowires exhibit outstanding methanol tolerance ability. For example, there is less than about 25%, less than about 20%, or less than about 15% loss in the specific activity in the presence of 4 mM of methanol. For example, 85% of the original activity of Pd_{0.90}Ni_{0.10} nanowires was preserved in an electrolyte containing a relatively high 4 mM methanol concentration, i.e., there was only a 15% loss in the specific activity in the presence of 4 mM of methanol.

In one embodiment, the ultrathin palladium-transitional metal composite nanowire has deposited thereon a platinum monolayer to form core-shell Pt˜Pd₁₋ₓYₓ nanowires. In a typical embodiment the transitional metal is nickel. The specific activity of these core-shell nanowires are about 0.5 to about 0.8 mA/cm² and a mass activity of about 1 to 2 A/mg_{Pt}.

For example, the electrochemical properties of Pd_{0.90}Ni_{0.10} nanowires, possessing a Pt monolayer shell, were tested. The results demonstrate outstanding ORR performance with a measured specific activity and platinum mass activity of 0.62 mA/cm² and 1.44 A/mg_{Pt}, respectively. After 10000 cycles of durability testing under realistic simulated conditions, the corresponding specific activity of the as-prepared Pt˜Pd_{0.90}Ni_{0.10} electrocatalyst actually increased by more than 20% from 0.62 mA/cm² to 0.76 mA/cm².

Without wanting to be bound to a mechanism, the improvement in both catalytic performance and stability is attributed, not only to the surface contraction of the Pt layer due to the small dimensions of the wires, but also to the electronic effect that the nanoscale Pd—Ni alloy core imparts to the outer Pt monolayer shell.

These one dimensional Pd—Ni nanostructures are useful for designing ORR catalysts. These nanowires are a more earth-abundant, lower cost, high-performance, and, therefore, attractive alternative to the conventional use of Pt nanoparticles as ORR catalysts.

The nanowires of the present invention are substantially free of organic contaminants (e.g., capping agents, surface ligands or surfactants) and impurities (e.g., non-metallic impurities, such oxides, halides, sulfides, phosphides, or nitrides) without employing additional purification steps.

Additionally, the nanowires are free of organic surfactant molecular groups (including nonionic surfactants, cationic surfactants, and anionic surfactants), such as bis(2-ethylhexyl)sulphosuccinate, undecylic acid, sodium dodecyl sulfate (SDS), Triton X-100, decylamine, or double-hydrophilic block copolymers, which are present on the surfaces of prior art nanostructures.

The nanowires of the invention are crystalline and solid. Preferably, the nanowires are at least 95%, more preferably at least 99%, and most preferably virtually completely free of defects and/or dislocations. As defined in this specification, defects are irregularities in the crystal lattice. Some examples of defects include a non-alignment of crystallites, an orientational disorder (e.g., of molecules or ions), vacant sites with the migrated atom at the surface (Schottky defect), vacant sites with an interstitial atom (Frenkel defects), and non-stoichiometry of the crystal. An example of a dislocation is a line defect in a crystal lattice.

### Methods of Making the Ultrathin Pd Nanowires

In one embodiment, the present invention provides a method of producing the ultrathin palladium-transitional metal composite nanowires. The method is ambient and surfactant-based. The method comprises mixing a palladium salt, a first row transitional melt salt, a surfactant and a phase transfer agent to form a mixture; adding a reducing agent to the mixture; and isolating the nanowires. The relative amount of the palladium and the transitional metal in the mixture correlate to the desired atomic ratio of the palladium and transitional metal in the composite nanowires. The amount of palladium relative to the transitional metal is at least 60%.

Palladium salts and first row transitional melt salts would be known to a skilled artisan. In one embodiment, the palladium salt and the first transitional metal salts are nitrates and/or chlorides. For example, palladium (II) nitrate and nickel (II) chloride can be used.

An example of a suitable surfactant is octadecylamine (ODA). The phase transfer agent facilitates the migration of a reactant from one phase into another phase where reaction occurs. Suitable examples of such agents include quaternary ammonium salts, e.g., dodecyltrimethylammonium bromide (DTAB). Suitable reducing agents include metal borohydrides, e.g., sodium borohydride.

In a further embodiment, the present invention provides a method to remove residual surfactant from the nanowires. The method comprises dispersing the composite nanowires in butylamine to exchange the surfactant with the butylamine; and depositing the nanowires onto a glassy carbon electrode and cycling the potential from zero up to about 1.5V at a rate of about 100 mV/second.

For example, the removal is accomplished by a two-step protocol. In the first step, a surface ligand exchange was performed by dispersing the as-prepared composites into n-butylamine by sonication, and the resulting dispersion was stirred for a period of three days in order to ensure complete exchange of the ODA with the butylamine. The treated product was subsequently isolated by centrifugation and washed with ethanol in order to remove excess butylamine.

In the second step, the butylamine ligands and other organic impurities were removed by selective CO adsorption process. In particular, the supported nanowires were deposited onto a glassy carbon electrode and the potential was cycled in deoxygenated 0.1 M HClO₄ up to a potential of 1.3 V at a rate of 100 mV/s until a stable profile was obtained. Thereafter, the electrode was immersed in a CO-saturated electrolyte for 30-45 min, so as to selectively displace residual organic impurities from the surfaces of the NWs. The electrode was then washed in ultrapure water and transferred to a freshly deoxygenated electrolyte, wherein a CO stripping cyclic voltammogram (CV) was obtained by cycling the potential up to 1.15 V. The CO adsorption/stripping process was ultimately repeated for an additional two times or until the CO stripping profile was deemed to be reproducible.

### EXAMPLES

An ambient, surfactant-based synthetic means was used to prepare ultrathin binary (‘d’˜2 nm) Pd—Ni nanowires, which were subsequently purified using a novel butylamine-based surfactant exchange process coupled with an electrochemical CO stripping treatment in order to expose active surface sites. The chemical composition of as-prepared Pd-Ni nanowires was systematically varied from pure elemental Pd to Pd_{0.50}Ni_{0.50} (atomic ratio), as verified using EDS analysis. The overall morphology of samples possessing greater than 60 atom % Pd consisted of individual, discrete one-dimensional nanowires. The electrocatalytic performances of elemental Pd, Pd_{0.90}Ni_{0.10}, Pd_{0.83}Ni_{0.17}, and Pd_{0.75}Ni_{0.25} nanowires in particular were examined. The results highlight a “volcano”-type relationship between chemical composition and corresponding ORR activities with Pd_{0.90}Ni_{0.10} yielding the highest activity (i.e. 1.96 mA/cm² at 0.8 V) amongst all nanowires tested. Moreover, the Pd_{0.90}Ni_{0.10} sample exhibited outstanding methanol tolerance ability. In essence, there was only a relatively minimal 15% loss in the specific activity in the presence of 4 mM methanol, which was significantly better than analogous data on Pt nanoparticles and Pt nanowires. In addition, also studied were ultrathin, core-shell Pt˜Pd_{0.90}Ni_{0.10} nanowires, which exhibited a specific activity of 0.62 mA/cm² and a corresponding mass activity of 1.44 A/mg_{Pt} at 0.9 V. Moreover, the as-prepared core-shell electrocatalysts maintained excellent electrochemical durability. The one-dimensional Pd-Ni nanostructures are a suitable platform for designing ORR catalysts with high performance.

Synthesis. Unsupported ultrathin Pd—Ni nanowires were prepared utilizing a modified procedure previously reported by Teng et al. (“Synthesis of ultrathin palladium and platinum nanowires and a study of their magnetic properties,” Angew Chem. Int. Ed. Engl. 2008; 47(11):2055-8). Briefly, in a typical synthesis experiment, palladium(II) nitrate (Alfa Aesar, 99.9%), nickel(II) chloride (Fisher Scientific, >96%), octadecylamine (ODA, 400 mg, Acros Organics, 90%), and dodecyltrimethylammonium bromide (DTAB, 60 mg, TCI, >99%) were dissolved in 7 mL of toluene under vigorous magnetic stirring. The amounts of two metallic precursors were correlated with the desired atomic ratios of these two elements, and the total amount was fixed at 0.056 mmol. For example, to obtain a chemical composition of Pd_{0.75}Ni_{0.25}, the amount of palladium(II) nitrate was 0.042 mmol, whereas the amount of nickel(II) chloride was 0.014 mmol.

The entire mixture was brought under an argon atmosphere, utilizing standard air-sensitive Schlenk-line procedures, and was subsequently sonicated for 20 min. Separately, solid sodium borohydride (13 mg, Alfa Aesar, 98%) was dissolved into 2 mL of deoxygenated distilled water, and the solution was added dropwise into the precursor mixture while stirring. After 1 h, the reaction mixture was diluted with 2 mL aliquots of distilled water and chloroform, thereby resulting in the separation of the organic and aqueous phases. The black organic phase containing the desired nanowires was then isolated, diluted with 10 mL of absolute ethanol, and eventually centrifuged for 10 min, ultimately resulting in the precipitation of a black solid. The black solid was subsequently washed several times with ethanol and allowed to dry in air.

Adsorption of these as-prepared nanowires onto conductive carbon support (Vulcan XC-72, Cabot) was achieved by first dispersing the isolated black solid, containing a mixture of Pd nanowires and residual surfactant into 6 mL of chloroform, until a homogeneous black mixture was formed. An equal mass of Vulcan carbon (i.e., ˜6 mg) was then added to this mixture, and the mixture was subsequently sonicated for 30 min in a bath sonicator. As-prepared composites were then isolated by centrifugation and fixed onto the carbon substrate by immersion in hexanes for 12 h. Excess ODA and DTAB were removed by washing the powder several times with hexanes and ethanol.

Activation of Pd-Ni Nanowires. The removal of residual adsorbed ODA surfactant was accomplished by a two-step protocol. In the first step, a surface ligand exchange was performed by dispersing the as-prepared composites into n-butylamine (Acros Organics, +99.5%) by sonication, and the resulting dispersion was stirred for a period of 3 days to ensure complete exchange of the ODA with the butylamine. The treated product was subsequently isolated by centrifugation and washed with ethanol to remove excess butylamine.

In the second step, the butylamine ligands and other organic impurities were removed by a selective CO adsorption process described in Koenigsmann et al., “Enhanced Electrocatalytic Performance of Processed, Ultrathin, Supported Pd—Pt Core-Shell Nanowire Catalysts for the Oxygen Reduction Reaction,” J. Am. Chem. Soc., 2011, 133(25):9783-95. Briefly, the supported nanowires were deposited onto a glassy carbon electrode, and the potential was cycled in deoxygenated 0.1 M HClO₄ up to a potential of 1.3 V at a rate of 100 mV/s until a stable profile was obtained. Thereafter, the electrode was immersed in a CO-saturated electrolyte for 30-45 min so as to selectively displace residual organic impurities from the surfaces of the NWs. The electrode was then washed in ultrapure water and transferred to a freshly deoxygenated electrolyte, wherein a CO stripping cyclic voltammogram (CV) was obtained by cycling the potential up to 1.15 V. The CO adsorption/stripping process was ultimately repeated an additional two times or until the CO stripping profile was deemed to be reproducible.

Regarding the commercial Pt nanoparticle (NP)/C samples, a pretreatment protocol was employed not only to successfully remove any trace organic impurities but also to preserve the intrinsic size and morphology of the nanoparticles themselves (Koenigsmann et al., Nano Lett., 2012, 12(4):2013-20; Koenigsmann et al., J. Phys. Chem. C., 2012, 116(29):15297-15306; and Sasaki et al., Nat. Commun. 2012, 3). Specifically, the Pt NP/C controls were treated by cycling between 0 and 1.0 V (versus RHE) in 0.1 M HClO₄ until a stable CV profile was achieved.

Structural Characterization. X-ray diffraction (XRD) measurements were performed using a Scintag diffractometer. Patterns were typically collected over 35-95° in the Bragg configuration with a step size of 0.25° using Cu Kα radiation (λ=1.5415 nm). TEM images and energy dispersive X-ray spectroscopy data collected in scanning TEM mode (TEM-EDAX) were obtained on a JEOL 1400 transition electron microscope equipped with a 2048×2048 Gatan CCD camera at an accelerating voltage of 120 kV. To improve the signal-to-noise in general, the EDAX spectral background was effectively eliminated by subtracting the signal attributed to the blank regions on the TEM grid from the desired response of the actual samples. In so doing, signals associated with the Cu peak (originating from the Cu grid) and the Fe peak (intrinsically incorporated within the sample holder) were essentially removed, thereby allowing for the unambiguous observation and interpretation of the highlighted Ni peak. High-resolution transmission electron microscopy (HRTEM), high angle annular dark field images (HAADF), and selected area electron diffraction (SAED) patterns were collected on a JEOL 2100F analytical transmission electron microscope equipped with a Gatan CCD camera and a Gatan HAADF detector and operating at an accelerating voltage of 200 kV.

Thermogravimetric analysis was performed using a TGA Q500 (TA Instruments) on dried aliquots of the catalyst ink to estimate the total metal content. Isotherms were obtained by raising the temperature from 25 to 900° C. at a rate of 10° C./min under a flow of extra-dry air provided at a rate of 60 mL/min. The mass profiles confirmed that the carbonaceous material (e.g., Vulcan XC-72R and residual organic surfactants) was entirely removed once a threshold level of 600° C. had been achieved. On the basis of two separate experiments, TGA measurements established that the combined Pd and Ni loading was 14.9±1.2%.

Electrochemical Characterization. Prior to electro-chemical characterization, as-prepared isolated nanowires were rendered into catalyst inks by dispersing the dry powders into ethanol so as to create an approximately 2 mg/mL solution. Before application of the nanowire ink, a glassy carbon rotating disk electrode (GC-RDE, Pine Instruments, 5 mm) was polished until a pristine finish was obtained. Then the electrode was modified by drying two 5 μL drops of the dispersed catalyst ink onto the surface and allowing them to dry in air. Once dry, the electrode was sealed with one 5 μL drop of an ethanolic 0.025% Nafion solution prepared from a 5% stock solution (Aldrich). Electrochemical measurements were obtained in a 0.1 M perchloric acid (Fisher Scientific, Optima grade) solution prepared using high-purity type 1 water possessing a high resistivity of 18.2 MΩ·cm. A Ag/AgCl (3 M CF) combination isolated in a double junction chamber (Cypress) and a platinum foil served as the reference electrode and the counter electrode, respectively. All of the potentials herein are reported with respect to the reversible hydrogen electrode (RHE) unless otherwise mentioned.

In addition to a Pd-Ni nanoscale alloy, a Pt˜PdNi core-shell structure was also prepared through a two-step Pt deposition method, and its electrochemical properties were investigated thereafter. Specifically, after CO stripping was performed, a monolayer of Cu was deposited onto the surface of Pd_{0.90}Ni_{0.10} NWs by Cu underpotential deposition (UPD) from a deoxygenated solution of 50 mM CuSO₄, maintained in a 0.10 M H₂SO₄ electrolyte (Wang et al., J. Am. Chem. Soc., 2009, 131(47):17298-302). The Cu monolayer-modified electrode was then transferred to a solution of 1.0 mM K₂PtCl₄ solution in 50 mM H₂SO₄ for several minutes. The Pt-monolayer-modified electrode was subsequently removed from the cell and rinsed thoroughly before ORR measurements were performed.

The measurement of the ORR performance of the various catalyst samples was carried out by employing a thin-layer rotating disk electrode method, a protocol recently reviewed in detail by Kocha and co-workers (Garsany et al., Anal. Chem., 2010, 82(15):6321-28). First, CVs were obtained in deoxygenated electrolyte at a scan rate of 20 mV/s so as to establish the electrochemically accessible surface area (ESA). The ESA is calculated in this case by converting the average of the hydrogen adsorption (H_{ads}) and desorption (H_{des}) charge (after correcting for the double layer) into a real, actual surface area by utilizing 210 μC/cm² as a known conversion factor. For Pt˜Pd and Pt˜Pd_{0.90}Ni_{0.10} samples, the ESA was computed by averaging the H_{ads} and the Cu UPD charge values to achieve a more accurate and representative estimate of the electrochemical surface area (Stamenkovic et al., Science, 2007, 315(5811):493-7; Bandarenka et al., Angew. Chem. Int. Ed., 2012, 51(47):11845-8). Then, the ORR activity of the various catalyst samples was measured by obtaining polarization curves in oxygen-saturated electrolytes at 20° C. with the electrode rotated at a rate of 1600 rpm and the potential scanned at a rate of 10 mV/s. The kinetic current density was calculated from the Koutecky-Levich relationship, and it was then normalized to either the ESA or the platinum mass of the catalyst loaded onto the GCE to determine either the surface area or normalized kinetic current (Jₖ) densities. Each experiment was performed up to three times to confirm reproducibility of results.

Durability testing was conducted on Pt˜Pd_{0.90}Ni_{0.10} electro-catalysts under half-cell conditions in perchloric acid by utilizing a durability test protocol standard, previously described by the U.S. Department of Energy (The US DRIVE Fuel Cell Technical Team Technology Roadmap; revised June 2013) for simulating a catalyst lifetime under realistic membrane electrode assembly operating conditions. Specifically, the potential was cycled from 0.6 to 1.0 V in an acidic 0.1 M HClO₄ medium and left open to the atmosphere. Data on ESA and the corresponding electrochemical surface area activity were obtained after every 5000 cycles.

Synthesis and Structural Characterization of Pd-Ni Nanowires with Various Chemical Compositions. An ambient, surfactant-based technique was employed to synthesize Pd-Ni ultrathin nanowires with a diameter of ˜2 nm. This synthetic approach has been previously used to yield long, extended polycrystalline nanowires, which possess lengths of several tens of nanometers and consist of single crystalline constituent segments (Koenigsmann et al., J. Phys. Chem. C., 2012, 116(29):15297-15306; Teng et al., Angew Chem. Int. Ed. Engl. 2008; 47(11):2055-8); Koenigsmann et al., J. Am. Chem. Soc., 2011, 133(25):9783-95). Specifically, appropriate metal precursors (namely, Pd²⁺ and Ni^{2±}) were reduced by sodium borohydride (NaBH₄) in the presence of octadecylamine (ODA) and n-dodecyltrimethyl-ammonium bromide (DTAB), serving as surfactant and phase transfer agent, respectively, to create thermodynamically unstable, elongated primary nano-structures (PNs). The secondary growth of these PN “nuclei” along preferred growth directions, including the (111) direction, leads to the formation of thread-like nanowire networks.

In the present invention, a synthetic protocol is used to tune chemical composition. The stoichiometry of NWs is directly altered by modifying the corresponding stoichiometric ratio of the metallic precursors within the precursor solution. In this case, Pd—Ni nanowire samples can be routinely and controllably prepared with chemical compositions ranging from Pd_{0.90}Ni_{0.10} to Pd_{0.50}Ni_{0.50}.

X-ray powder diffraction (XRD) obtained on the series of as-prepared Pd-Ni nanowires reveals that the NWs are composed of homogeneous alloys with a face-centered cubic (fcc) crystal structure. No obvious peaks were observed associated with either the metallic nickel or nickel oxides observed, thereby suggesting the incorporation of Ni atoms within the fcc structure of Pd. Nonetheless, on the basis of studies that involve a cross-sectional composition analysis of Pd—Ni or Pt—Ni nanostructures, it is possible that though the valence of Ni in the core region is 0, the Ni on the surface may actually exist as a form of oxide, such as NiO or Ni(OH)₂ as a result of the presence of surface oxidation. Therefore, it is likely that the as-prepared nanostructures of the present invention possess a variant of nickel oxide on their surfaces, as well. Nevertheless, the patterns of the peaks can be attributed to the elemental Pd phase with a slight shift toward higher 2θ angle, indicating possible lattice contraction. Such a phenomenon reflects a partial substitution of Pd atoms with Ni atoms, which possess a smaller atomic radius. Because of a broadening of the peaks, which likely originates from the small crystallite size, calculations of lattice parameters based on XRD patterns tend to be difficult and, hence, could be somewhat imprecise. Consequently, lattice parameters were more precisely determined by analyzing the corresponding selective area electron diffraction (SAED) patterns.

Transmission electron microscopy (TEM) was employed to examine the morphology, crystallinity, and uniformity of a series of as-prepared Pd-Ni nanowires. The overall structure of the samples with >60 atom % Pd consists of discrete individual one-dimensional nanowires clustered together as part of a larger three-dimensional aggregated network. In the past, this specific synthetic protocol has been applied only to noble metals and noble metal alloys, namely, Pt, Pd, and Au.

In addition, it is proposed that the growth mechanism involves the surfactant-directed assembly of discrete anisotropic seed nanocrystals into elongated nanowires composed of individual segments. An analogous way of describing this growth mechanism, especially for ultrathin nanowires, is that it can be viewed as not only ligand-controlled but also associated with an oriented attachment of nanoparticulate building blocks. This unique growth mechanism renders the reaction process itself sensitive to the presence of oxygen, which can selectively adsorb onto and etch the edges of the growing nanowire, thereby leading to shorter nanorods in the presence of dissolved O₂ and longer nanowires in the absence of O₂. Thus, the introduction of non-noble metals, for example, Ni, which are much more prone to oxidation than their noble metal counterparts, may likely hinder the assembly of constituent substructural seeds. Moreover, the higher the content of Ni, the more difficult the assembly process, and hence, the more challenging the resulting nanowire formation is.

A high-resolution TEM (HRTEM) image revealed that the NWs are actually polycrystalline and are composed of multiple single crystalline segments. The selected area electron diffraction (SAED) pattern highlights the likelihood of such structure by showing not only continuous rings that can be indexed to the (111), (200), (220), (311), and (331) reflections for the calculated fcc Pd_{0.90}Ni_{0.10} alloy but also discrete diffraction spots, indicative of the high degree of crystalline substructure. Therefore, on the basis of the collected electron diffraction data, the Pd_{0.90}Ni_{0.10}, Pd_{0.83}Ni_{0.17}, and Pd_{0.75}Ni_{0.25} NWs were experimentally determined to possess lattice parameters of 3.856, 3.836, and 3.796 Å, respectively, which are in agreement with the calculated values of 3.861, 3.831, and 3.806 Å for the respective alloys.

Theoretical calculations generated by utilizing a reliable software package, that can calculate phase diagrams, have shown that Pd₁₋ₓNiₓ tends to form a homogeneous alloy with an fcc structure under ambient conditions wherein “x” is no greater than 0.7. In other words, for all of the sample compositions synthesized herein, the corresponding alloys should possess a homogeneous chemical structure. Indeed, the XRD and HRTEM data collectively suggest that the as-prepared Pd₁₋ₓNiₓ NWs are, in fact, uniform and homogeneous, because no diffraction data or other compelling evidence were observed for the formation of either Pd, Ni, or their related oxides.

A high angle annular dark field (HAADF) imaging technique, which is sensitive to atomic number (Z), was also used to further examine the homogeneity of chemical composition along the lengths of the as-prepared wires. A representative HAADF image was collected from a typical Pd_{0.90}Ni_{0.10} sample. The largely uniform contrast observed over the collection of individual discrete NWs present is suggestive of a high degree of homogeneity of chemical composition. The brighter contrast at the center of the collection and within some spherical areas can be attributed to signals emanating from physically overlapping nanowires as well as from discrete interconnects among the NW segments. Such an observation has also been noted in analogous Pd₉Au NWs in previous reported work.

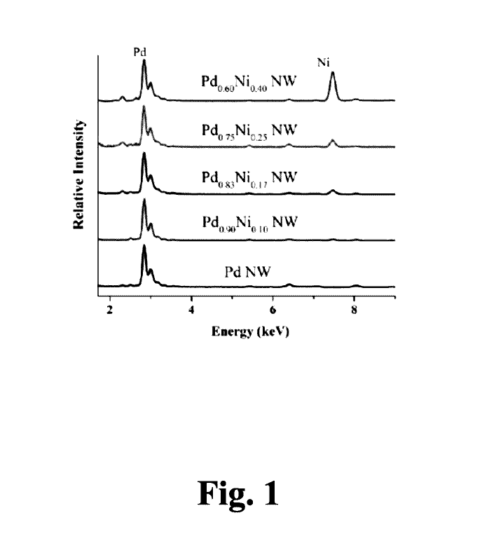

Representative point EDS spectra, corresponding to the elemental composition of areas measuring as small as several square nanometers, were collected over multiple locations for all of the as-prepared 1-D nanostructures, and these are shown in FIG. 1. The diameters of various as-prepared Pd_{0.90}Ni_{0.10}, Pd_{0.83}Ni_{0.17}, Pd_{0.75}Ni_{0.25}, Pd_{0.60}Ni_{0.40}, and Pd_{0.50}Ni_{0.50} nanostructures along with their actual chemical compositions obtained thorough EDAX analysis are summarized in Table 1. The small deviation in both diameter and atomic composition observed validates the idea of a high uniformity of these as-prepared nanowires in terms of both (a) morphology and (b) Pd and Ni content.

TABLE 1
Summary of the Morphologies, Diameters, and Actual Chemical
Compositions, as Determined by EDAX Analysis, of As-Prepared
Pd—Ni Nanowires with Various Pd/Ni Molar Ratios

| | | | actual | standard |
|---|---|---|---|---|
| precursor | | | composition | deviation of |
| metal | | diameters | (Pd/Ni, molar | chemical |
| composition | morphology | (nm) | ratio)^{a} | composition^{a} |
| Pd_{0.90}Ni_{0.10} | wires | 2.7 ± 0.3 | Pd_{0.92}Ni_{0.08} | 0.02 |
| Pd_{0.83}Ni_{0.17} | wires | 2.3 ± 0.2 | Pd_{0.84}Ni_{0.16} | 0.04 |
| Pd_{0.75}Ni_{0.25} | wires | 2.1 ± 0.3 | Pd_{0.77}Ni_{0.23} | 0.03 |
| Pd_{0.60}Ni_{0.40} | short wires | 2.4 ± 0.2 | | |
| Pd_{0.50}Ni_{0.50} | short | 2.3 ± 0.4 | | |
| | wires/segments | | | |

^{a}Chemical compositions of Pd_{0.60}Ni_{0.40} and Pd_{0.50}Ni_{0.50} short wires were not precisely examined because these materials were not used in subsequent electrochemical tests.

Regarding electrochemical characterization, the main focus has been directed to Pd_{0.90}Ni_{0.10}, Pd_{0.83}Ni_{0.17}, and Pd_{0.75}Ni_{0.25} because they are useful for ORR. The nanowire samples maintained chemical compositions that were rather close to the expected values with a minimal deviation of 3% from batch to batch. Specifically, the actual compositions of these three nanostructures were deemed to be Pd_{0.92}Ni_{0.08} (±0.02), Pd_{0.84}Ni_{0.16} (±0.04), and Pd_{0.77}Ni_{0.23} (±0.03), respectively.

Electrochemical Properties and ORR Performance of Pd—Ni Nanowire Series. In prior studies, a treatment protocol was developed for the removal of residual organic impurities from the surfaces of ultrathin Pd nanowires, which combined (i) a UV-ozone atmosphere pretreatment with (ii) a selective CO adsorption process.

In the present invention, however, a different two-step protocol is used to include a more facile and “greener” pretreatment process involving a simple surface-capping ligand substitution with butylamine. In previous reports, ligand substitution reactions were effectively employed to remove a mixture of a borane-tert-butylamine complex and hexadecane-diol from the surfaces of Pt₃Ni nanoparticles, for instance. Herein, the ligand substitution was accomplished by dispersing as-synthesized ODA-capped PdNi alloy nanowires into pure butylamine for a period of 3 days under completely ambient conditions. The subsequent butylamine-capped nanowires could be activated toward a selective CO-adsorption process, which is capable of displacing organic capping ligands with alkyl chains of up to six carbons in length.

That is, it has been demonstrated that the selective CO stripping process alone is not capable of fully removing the ODA; however, in combination with a ligand substitution reaction using the 4-carbon butylamine molecule, the selective CO adsorption process can successfully produce electrochemical features in the CV profile associated with pristine Pd nanostructures, while at the same time, conserving its overall wire morphology.

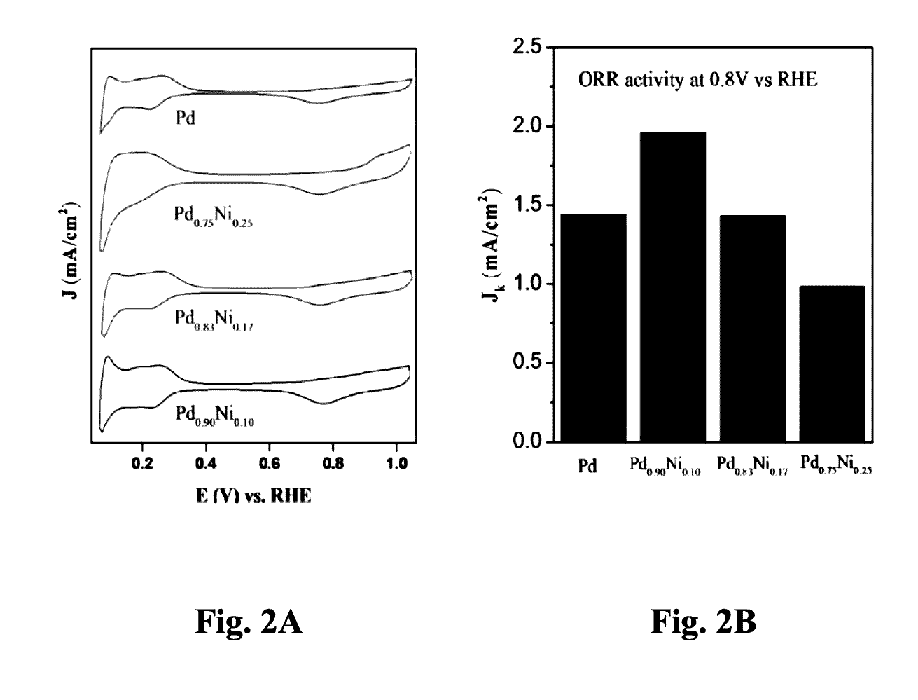

The cyclic voltammograms along with the associated specific ORR activities measured at 0.8 V are displayed in FIGS. 2A and B. As compared with elemental palladium, the onset potentials for the oxide species in the cyclic voltammograms of the Pd—Ni series have been shifted to lower potentials, an observation that is consistent with the incorporation of Ni into the Pd-based alloy, thereby leading to a lower overall potential for the onset of surface oxide formation. Moreover, the positions of the oxide reduction peaks in Pd—Ni CVs shifted toward higher potential (relative to Pd) as a result of the “ligand effect” arising from the Ni content. This could be rationalized by the Nørskov-Hammer theory, which implies that Ni as a dopant withdraws electron density away from Pd, thereby weakening the interaction between Pd itself and the resulting oxide species. Interestingly, however, Pd_{0.90}Ni_{0.10} shows the largest shift (769.3 mV as compared with 752.2 mV for elemental Pd), followed by Pd_{0.83}Ni_{0.17} (759.8 mV) and, finally, Pd_{0.75}Ni_{0.25} (755.2 mV).

Such observations are attributed to the combination of the Ni doping effect and the oxophilic nature of Ni atoms themselves. In essence, the doping effect or “ligand effect” should imply a direct proportional relationship between the amount of dopant and the magnitude of the shift in the oxide reduction peak. However, this is only true with a small quantity of dopant. In fact, when the molar percentage of the non-noble metal exceeds a certain value (in this case, 10% of Ni), the oxophilicity of nickel was a more significant factor than the ligand effect, thereby rendering the wire structure more prone to oxidation.

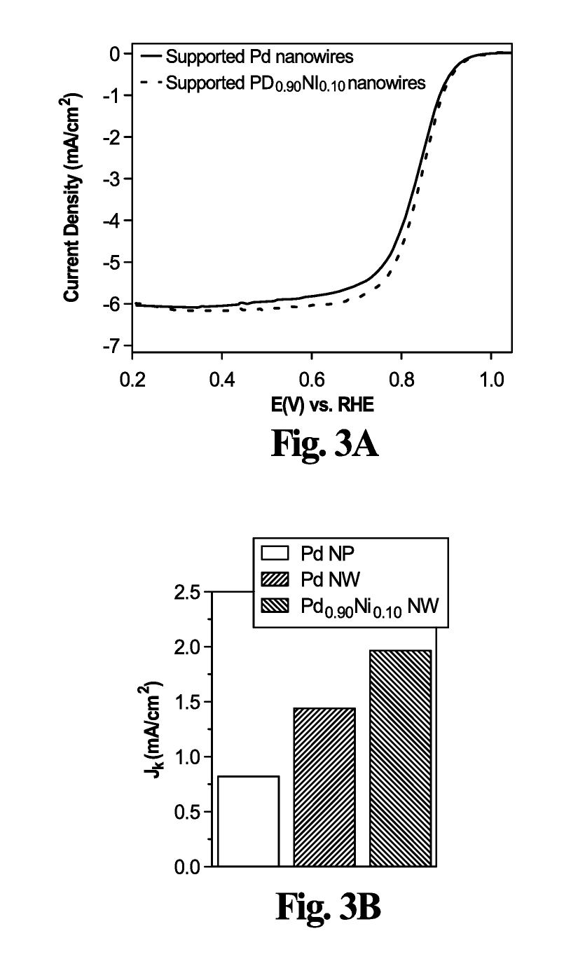

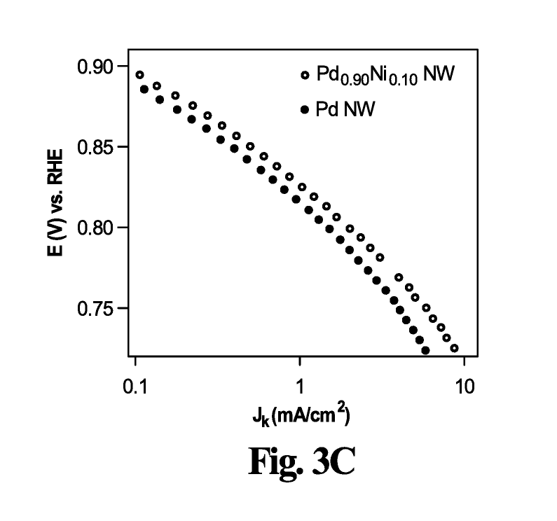

As FIG. 2B has shown, the activities of the series (including elemental Pd) exhibited a “volcano”-shaped trend in which the highest activity was provided by the Pd_{0.90}Ni_{0.10} sample, namely, at 1.96 mA/cm² measured at 0.8 V. A direct comparison of the specific activities of the supported Pd_{0.90}Ni_{0.10} and elemental Pd nanowires is shown in FIG. 3. On the basis of the polarization curves obtained in an oxygen-saturated electrolyte (FIG. 3A), the Pd_{0.90}Ni_{0.10} NWs possess significantly enhanced performance, especially as compared with elemental Pd NWs and commercial Pd NP/C (FIG. 3B). Moreover, the potential versus specific activity (E versus Jₖ) plot (FIG. 3C) further confirms the consistently improved performance of Pd_{0.90}Ni_{0.10} nanowires with respect to analogous elemental Pd nanowires over a broad range of plausible fuel cell potentials.

In prior research studying the utilization of Pd—Ni nanoparticles as ORR electrocatalysts, the “optimum composition” was found to be Pd_{0.60}Ni_{0.40}. By contrast, in the present invention, the Pd₁₋ₓNiₓ NW electrocatalysts maintain an optimum performance with a composition of Pd_{0.90}Ni_{0.10}. This interesting morphology-dependent finding may have several plausible explanations. First, this difference in behavior can be potentially attributed to a corresponding difference between the surface structure and composition of the Pd—Ni NPs and NWs. Specifically, recent theoretical work has demonstrated that the surface segregation of Pd atoms occurs at the catalytic interface (i.e., the 1-3 uppermost atomic layers) and that the surface composition and structure of the dealloyed surface varies significantly for exposed (111), (100), and (110) facets, respectively. It is typically observed that noble metal NWs possessing diameters measuring 2 nm expose primarily (111) and (100) facets with a relatively low defect site density, whereas the corresponding analogous NPs maintain predominantly (111)-terminated facets with a relatively large density of (110)-type defect sites. In addition, the degree of Pd enrichment and the corresponding surface structure are also highly dependent upon the surface strain, which is known to be comparatively different for nanoparticles versus nanowires because of their isotropic and anisotropic geometries, respectively. Hence, on the basis of this theory, it is proposed that significant differences in the surface structure and strain of the NWs and NPs may lead to differing degrees of surface segregation at the catalytic interface. It is proposed that, as a result of the morphology-dependent Pd enrichment, the surface layers of the reported Pd_{0.60}Ni_{0.40} nanoparticles and of the present Pd_{0.90}Ni_{0.10} nanowires likely possess approximately the same chemical composition at the interface and, therefore, a similar “active site” profile, thereby resulting in the comparably favorable ORR activities, experimentally recorded.

Second, as an alternative, complementary explanation for the observed activity enhancement of Pd alloys as compared with Pd alone, it is worth noting, from previous studies, that one of the roles of the second metal “dopant”, that is, Ni, is to lower the amount of potentially deleterious OH coverage on Pd by inducing lateral repulsion between OH species adsorbed on Pd and neighboring OH or O species adsorbed on Ni. Although this effect is minimal either at low pH or in an acidic environment, the net result of this interaction is to yield a positive shift associated with the formation of OH on Pd or, conversely, the oxidation of PdNi itself. In principle, decreasing OH coverage on Pd should increase the number of free Pd “active” sites.

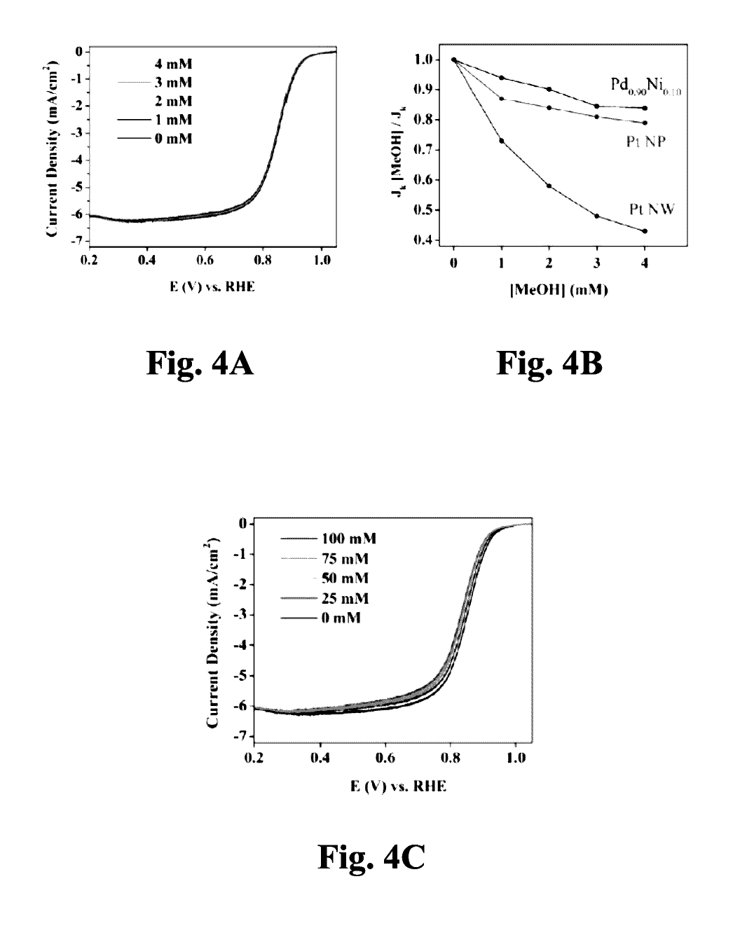

In the operation of DMFCs, the migration of methanol from the anodic half-cell to the cathodic half-cell often results in a deactivation of the catalyst. To further prove that the present Pd_{0.90}Ni_{0.10} nanowires are useful for ORR, methanol tolerance experiments were conducted. FIG. 4A displays polarization curves obtained from Pd_{0.90}Ni_{0.10} NWs in the presence of a range of methanol concentrations (i.e., 0-4 mM). It can be inferred from these data that at these levels, methanol exerts minimal effect on the shape and intensity of the measured polarization curves. A more quantitative analysis (shown in FIG. 4B) validates a high methanol tolerance ability for the systems. In fact, the purified Pd_{0.90}Ni_{0.10} NWs maintain a significantly improved tolerance to methanol by maintaining 85% of their initial activity in the presence of 4 mM methanol, which designates a tangible improvement, especially as compared with controls consisting of commercial elemental 0D Pt NP/C (79%) and 1D Pt NWs (43%).

Moreover, FIG. 4C shows a minimal difference of 20 mV in half-wave potential for polarization curves obtained in a mixture of 0.1 M HClO₄ and 100 mM MeOH solution as compared with an analogous polarization curve obtained in 0.1 M HClO₄ solution, thereby corroborating the high methanol tolerance ability of the nanowires. The fact that 55% of the initial activity for the Pd_{0.90}Ni_{0.10} nanowires was retained after these experiments should be considered noteworthy, especially given the fact that commercial Pt nanoparticles likely maintain either little or no ORR activity under identical experimental conditions and protocols. In addition, a comparison of CVs both in the presence of as well as in the absence of methanol, serving as a component of the electrolyte, further highlights that the main defining features of Pd_{0.90}Ni_{0.10} cyclic voltammograms are indeed preserved, even after the addition of methanol. Both the polarization curves and CV comparative analysis imply the absence of a CO-poisoning effect on the actual Pd_{0.90}Ni_{0.10} surface which would have been particularly detrimental to ORR performance.

It has been demonstrated in previous work that binary nanostructures, both 0-D and 1-D, represent a promising platform for the subsequent deposition of a Pt monolayer shell, and hence, one can envision forming core-shell ORR catalysts possessing outstanding performance, yet with a minimum amount of Pt metal. For example, a high-performing catalyst consisting of Pt decorating PdNi nanoparticles supported on carbon black has been shown to evince performance superior to that of analogous pure Pt, Pd, and PdNi, all supported on carbon black.

In the present invention, ultrathin Pt˜Pd_{0.90}Ni_{0.10} core-shell nanostructures, that display significant electrochemical improvement as compared with analogous ultrathin Pt˜Pd nanowires, have specifically been designed. The deposition of the platinum monolayer was accomplished by Cu UPD, followed by galvanic displacement of the Cu atoms with [PtCl₄]²⁻.

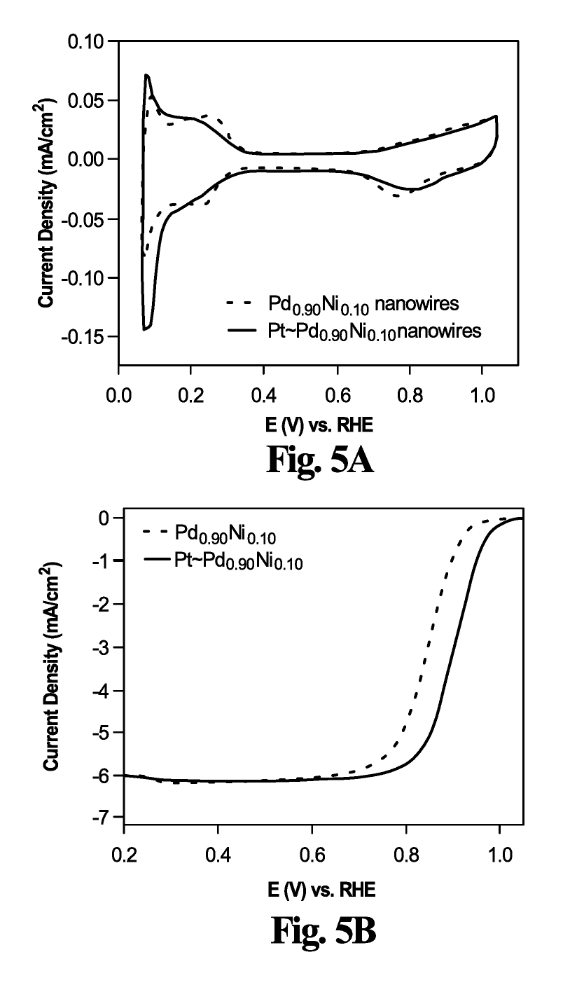

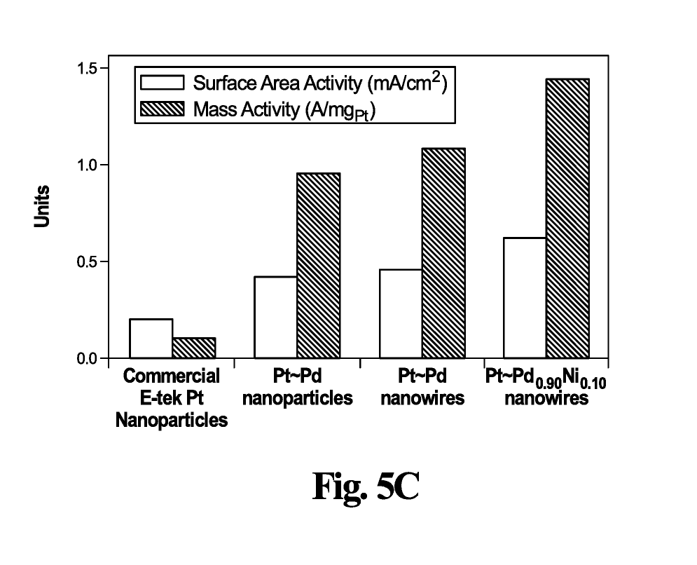

Cyclic voltammetric comparison of the Pd_{0.90}Ni_{0.10} and Pt˜Pd_{0.90}Ni_{0.10} composites (FIG. 5A) showed that after Pt deposition, the hydrogen adsorption region resembled that of a nanostructured Pt surface. Moreover, the oxidation and reduction peaks were shifted to higher potentials. The polarization curves of the corresponding samples are displayed in FIG. 5B. The Pt˜Pd_{0.90}Ni_{0.10} NWs possessed an ORR onset in the region of 0.9-1.0 V, which is consistent with that of nanostructured Pt catalysts. On the basis of the polarization curves, the specific activities and corresponding Pt mass activities at 0.9 V were measured by comparison with commercial platinum nanoparticles and are shown in FIG. 5C. Specifically, the Pt˜Pd_{0.90}Ni_{0.10} nanowires yielded area and mass activities of 0.62 mA/cm² and 1.44 A/mg_{Pt}, respectively.

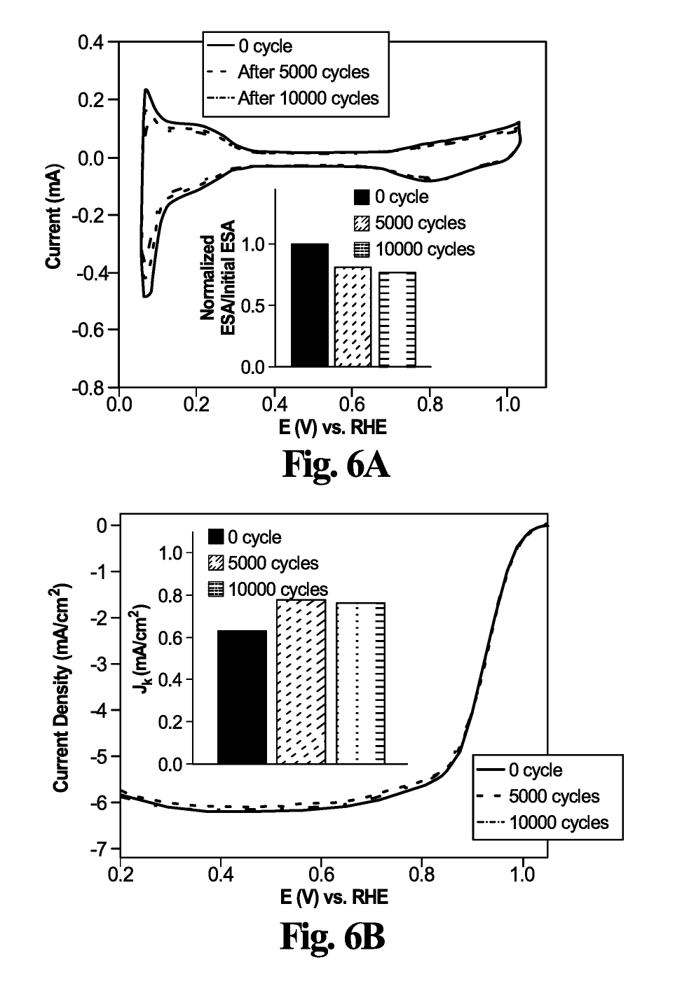

Moreover, the electrochemical durability of the processed Pt˜Pd_{0.90}Ni_{0.10} composites were tested under half-cell conditions. Specifically, the electrode was immersed in naturally aerated 0.1 M HClO₄ solution while the potential was cycled between 0.6 and 1.0 V to properly simulate the relevant electrochemical environmental conditions associated with ORR feasibly occurring within a functional working fuel cell configuration. On the basis of this protocol, the ESA as well as the specific activities could be independently probed by obtaining cyclic voltammograms (FIG. 6A) and polarization curves (FIG. 6B) through potential cycling, that is, through an accelerated degradation test (ADT).

The Pt˜Pd_{0.90}Ni_{0.10} catalytic architecture maintained 81% and 77% of their initial measured ESA values after 5000 and 10 000 cycles, respectively. This decline in ESA is comparatively more rapid as compared with the analogous Pt˜Pd ultrathin nanowires previously reported, which maintained ˜100% of ESA after 5000 cycles and 83% after 10 000 cycles. This accelerated ESA loss rate can potentially be attributed to the relative instability of Ni content in the material toward an acidic testing environment, because Ni is generally less inert than Pd and, hence, more prone to dissolution.

In addition, the specific activity, or surface area activity, of Pt˜Pd_{0.90}Ni_{0.10} has also been studied as a function of durability. As shown in FIG. 6B, despite a nearly 20% of ESA loss, the corresponding specific activity of the as-prepared electrocatalysts actually increased by more than 20% after 10 000 cycles (from 0.62 to 0.76 mA/cm²). As a matter of record, there was only a 2 mV loss of half-wave potential in the process. This promising result is in excellent agreement with a previous study of both Pt˜Pd nanoparticles and Pt˜Pd nanowires possessing analogous dimensions. Without wanting to be bound to a theory, the enhanced activity is attributed to the preferential dissolution of both Pd and Ni content in the core as well as to a restructuring of the Pt monolayer. Overall, the results demonstrate that the present Pt˜Pd_{0.90}Ni_{0.10} electrocatalysts possess excellent electrochemical stability.

Thus, while there have been described what are presently believed to be the preferred embodiments of the present invention, other and further embodiments, modifications, and improvements will be known to those skilled in the art, and it is intended to include all such further embodiments, modifications, and improvements as come within the true scope of the claims as set forth below.

1. A method of producing ultrathin palladium-transitional metal composite nanowires, the method comprising:
mixing a palladium salt, a transitional melt salt, a surfactant and a phase transfer agent to form a mixture, wherein the transitional metal is selected from the first row transitional metals;
adding a reducing agent to the mixture; and
isolating the nanowires,
wherein the relative amount of the palladium and the transitional metal in the mixture correlate to the atomic ratio of the palladium and transitional metal in the composite nanowires, wherein the amount of palladium is at least 60%, wherein the diameters of the composite nanowires are from about 1 nm to about 10 nm.

2. The method according to claim 1 wherein the palladium salt is palladium(II) nitrate.

3. The method according to claim 1 wherein the transitional metal salt is nickel(II) chloride.

4. The method according to claim 2 wherein the nanowire is PD_{0.90}Ni_{0.1}.

5. The method according to claim 1 wherein the surfactant is octadecylamine.

6. The method according to claim 1 wherein the phase transfer agent is dodecyltrimethylammonium bromide.

7. The method according to claim 1 wherein the reducing agent is sodium borohydride.

8. The method according to claim 1 wherein the diameters of the composite nanowire is less than about 10 nm.

9. The method according to claim 1 wherein the diameters of the composite nanowire is about 2 nm.

10. The method according to claim 1 further comprising removing residual surfactant, the method comprising:
dispersing the composite nanowires in butylamine to exchange the surfactant with the butylamine; and
depositing the nanowires onto a glassy carbon electrode and cycling the potential from zero up to about 1.5V at a rate of about 100 mV/second,
wherein residual surfactant is removed from the nanowires.

11. An ultrathin palladium-transitional metal composite nanowire having a diameter of about 1 nm to about 10 nm and having formula of Pd₁₋ₓYₓ, wherein x is at most 0.5, and Y is a first row transitional metal.

12. The ultrathin palladium-transitional metal composite of claim 11 having a diameter of about 2 nm.

13. The ultrathin palladium-transitional metal composite nanowire of claim 11, wherein the specific activity of the nanowire is about ±1.0 mA/cm² the specific activity of Pd nanowires.

14. The ultrathin palladium-transitional metal composite nanowire of claim 11, wherein the nanowire maintains at least about 70% of its area activity in the presence of about 4 mM methanol.

15. The ultrathin palladium-transitional metal composite nanowire of claim 11 further having deposited thereon a platinum monolayer.

16. The ultrathin palladium-transitional metal composite nanowire of claim 15 having deposited thereon a platinum monolayer having formula Pt˜Pd_{0.90}Ni_{0.10} and an area activity of about 0.5 to about 0.8 mA/cm² and a mass activity of about 1 to 2 A/mg_{Pt}.
